(19) United States
(12) Patent Application Publication
(10) Pub. No.: US 2005/0102236 A1
(43) Pub. Date: May 12, 2005

(54) Method for the protection of a digital content

(76) Inventor: Jean-Philippe Wary, Bourg La Reine (FR)

Correspondence Address: PERMAN & GREEN, 425 POST ROAD, FAIRFIELD, CT, 06824, US

(21) Appl. No.: 10/901,523

(22) Filed: Jul. 29, 2004

(30) Foreign Application Priority Data
Aug. 4, 2003 (FR) FR 03 50396

(51) Int. Cl. H04L 9/00

(52) U.S. Cl. 705/57

(57) ABSTRACT

To limit the illegal use of digital contents, these digital contents are watermarked as a function of the civil-status identity of the person who legally acquires the digital content. A user uses a terminal to control a digital content through a presentation server. The presentation server asks an identification server for an identification of the user. A watermarking server produces a watermarked digital content with a secret-key algorithm. The watermark incorporates at least the civil-status identity obtained by the presentation server. The digital content thus watermarked is conveyed up to the user either through an Internet type network or through a physical carrier. It is therefore possible, at any time, for an entity having access to the secret key, to know who is responsible for the fact that a digital content is out of control.

### BACKGROUND OF THE INVENTION

1. Field of the Invention

An object of the invention is a method for the protection of a digital content. A digital content is a succession of bits that can be recorded on any carrier amongst at least those carriers designated by the following terms: random-access memory, read-only memory, CD-ROM, DVD, floppies. This list is not exhaustive. A digital content therefore belongs to at least the set constituted by musical files, image files, video files, program files, and here again the list is not exhaustive. The field of the invention is therefore that of the distribution of digital contents, whatever the distribution media and, in particular, whether the distribution is done online or through a physical carrier.

It is an aim of the invention to restrict the illegal distribution of digital contents.

It is another aim of the invention to restrict the illegal distribution of digital contents in a way that entails few constraints for the consumer of these digital contents.

It is another aim of the invention to facilitate the detection of the illegal distribution of digital contents.

Yet another aim of the invention is to enable the source of an illegal distribution of digital contents to be traced in a simple way.

2. Description of the Prior Art

In the prior art, there are various known techniques for the protection of digital contents. One of these techniques consists in locking access to the digital content by using a proprietary encoding linked to a decoding software which itself is locked by a password for example. Another of these techniques consists in blocking the digital content on a carrier, for example a CD, as is already the case in certain musical works. Theoretically then, a CD can no longer be read by a device capable of duplicating its contents such as a personal computer.

Current protection techniques are constantly revealing their limits. Indeed, there is always somebody to make an algorithm available, through the Internet for example, to enable access to the digital content enciphered or protected on his carrier. This very quickly ruins the efforts that the owners of rights to digital contents make to protect these rights.

The application of current protection techniques may have extremely negative effects: for example, certain carriers may become illegible owing to the fact of the protection itself. In this case, the consumer who has legally acquired the digital content may find that he is unable to access the digital content owing to the inappropriate nature of his playback or reading equipment. This case is ever increasingly frequent for audio CDs. Indeed, certain protected audio CDs are no longer compatible with certain drawing-room decks. The effect obtained will run totally counter to the desired effect since, in the short term, the consumers confidence will be weakened. Indeed, the consumer would not want to have to purchase a specific deck for each technique for the protection of a digital content. The effect is especially harmful as these protection systems are not resistant for very long and as the digital content always ends up getting plundered.

In the invention, these problems are resolved by personalizing the digital contents without altering their format, and hence their compatibility with all the equipment approved for purposes of reading the format in question. This personalization consists of a marking that is imperceptible without appropriate tools. Said marking does not cause any disturbance in reading apparatuses and programs because it is compliant with the format of the digital content. Such a marking is also called watermarking by those skilled in the art. In the invention, this watermarking is personalized. This is done by watermarking a digital content at least with one identifier of the persons legally obtaining the digital content. The watermarking is done by means of a secret-key algorithm that makes it particularly robust, i.e. difficult to erase. The secret key is known only to owners authorized to distribute the digital content. When these owners intercept a digital content, they can therefore determine the individual to whom it has been distributed and, therefore, they can determine whether the digital content has been illegally used, for example in a peer-to-peer P2P network. This watermarking is done when an order is placed for the digital content. The person placing the order for the digital content is then made aware of his responsibilities and knows that it will be easy to detect him if he makes illegal use of the digital content that he has just acquired, or if he does not have recourse to the minimum degree of protection to prevent its misuse. Cryptographic techniques providing mutual authentication services, confidentiality, integrity and non-repudiation of transactions may be used during the exchanges necessary for the supply of a watermarked content to ensure the quality of the watermarking act and enable efficient fraud control at the legal level.

### SUMMARY OF THE INVENTION

An object of the invention therefore is a method for the protection of a digital content provided by a server of contents of a digital contents provider comprising the following steps:
a presentation server of a provider proposing access to digital contents accepts a connection by a user who is a subscriber with an operator controlling a private network and is setting up connection to said presentation server by means of a customer terminal and via at least this private network,
the user selects a digital content from among those presented by the presentation server, wherein the method comprises the following steps:
the presentation server obtains, from an identification server, an identifier called a durable civil-status identifier of the user, this durable civil-status identifier enabling the operator who controls the private network and has provided said durable civil-status identifier to make a durable civil-status identification of the user,
the presentation server transmits watermarking information comprising at least the durable civil-status identifier of the user and an identifier of the digital content selected by the user to a watermarking server, for the watermarking of the selected digital content.

Advantageously, the invention is also characterized by the fact that:
the watermarking server obtains the selected digital content from the content server; and produces a watermarked digital content incorporating the watermarking information transmitted by the presentation server and the digital content selected and obtained, the watermarked digital content being a file in the format of the digital content selected and obtained,
the watermarking server delivers the watermarked digital content to the user.

Advantageously, the invention is also characterized by the fact that the watermarking information comprises information on the digital management of the rights associated with the digital content.

Advantageously, the invention is also characterized by the fact that the watermarking information comprises information for limiting the use of the digital content.

Advantageously, the invention is also characterized by the fact that the private network is a telephony network.

Advantageously, the invention is also characterized by the fact that all or part of the user's durable civil-status identifier is a telephone number.

Advantageously, the invention is also characterized by the fact that the watermarking server is managed by the operator controlling the private network.

Advantageously, the invention is also characterized by the fact that the watermarking server is managed by the digital contents provider.

Advantageously, the invention is also characterized by the fact that the presentation server is managed by the digital contents provider.

Advantageously, the invention is also characterized by the fact that the obtaining of a durable user civil-status identifier by the presentation server is subjected to the approval of the identification server, this approval being given as a function of an identifier of the sender of an identification request or an authentication of the sender of the request.

Advantageously, the exchanges between the presentation, identification, watermarking, contents and connection servers are protected by a mutual authentication of the parties, by mechanisms of integrity control, mechanisms providing for the confidentiality of the exchanges, mechanisms guaranteeing the non-repudiation of exchanges, and mechanisms implementing cryptographic resources and conventions.

An object of the invention is also a device for the protection of a digital content provided by a contents server of a digital contents provider, wherein the device comprises:
a customer terminal capable of setting up connection with a presentation server through at least one private network, the presentation server being capable of presenting the user of the customer terminal with digital contents, the presentation server being furthermore capable of obtaining, from an identification server, a durable user civil-status identifier enabling the operator who controls the private network and has provided said durable user civil-status identifier to make a civil-status identification of the user, the identification server being capable of authorizing or not authorizing the issuance of the durable civil-status identifier as a function of the sender of the identification request, the presentation server being also capable of transmitting the durable user civil-status identifier and a digital content identifier to a watermarking server so that the watermarking server produces a watermarked digital content, the watermarking server being capable of obtaining the digital content to be watermarked from a digital contents server, the watermarking server being also capable of delivering the watermarked digital content.

### BRIEF DESCRIPTION OF THE DRAWINGS

The invention will be understood more clearly from the following description and the accompanying figures. These figures are given by way of an indication and in no way restrict the scope of the invention. Of these figures:

FIG. 1 illustrates steps of the method according to the invention.

FIG. 2 illustrates a network architecture in which the method according to the invention is implemented.

FIG. 3 illustrates fields of an identification request.

FIG. 4 illustrates fields of a response to an identification request.

FIG. 5 illustrates fields of a watermarking message.

### MORE DETAILED DESCRIPTION

In the following description, a server is equivalent to a computer. When action is attributed to a server, or to an apparatus in general, this action is performed by a microprocessor of the server controlled by instruction codes of a memory of the server. A server also has all the means needed for to be connected to one or more networks of the Internet, Ethernet, or other type.

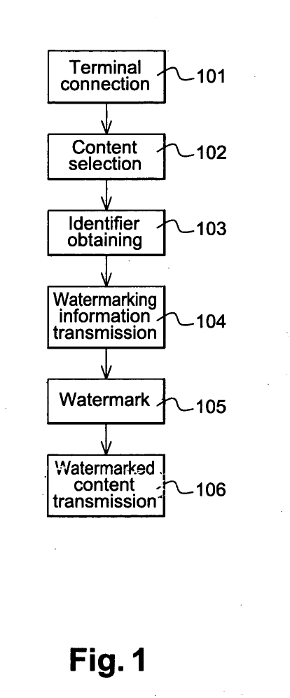

FIG. 1 shows a step 101 in which a user of a customer terminal sets up connected to a presentation server.

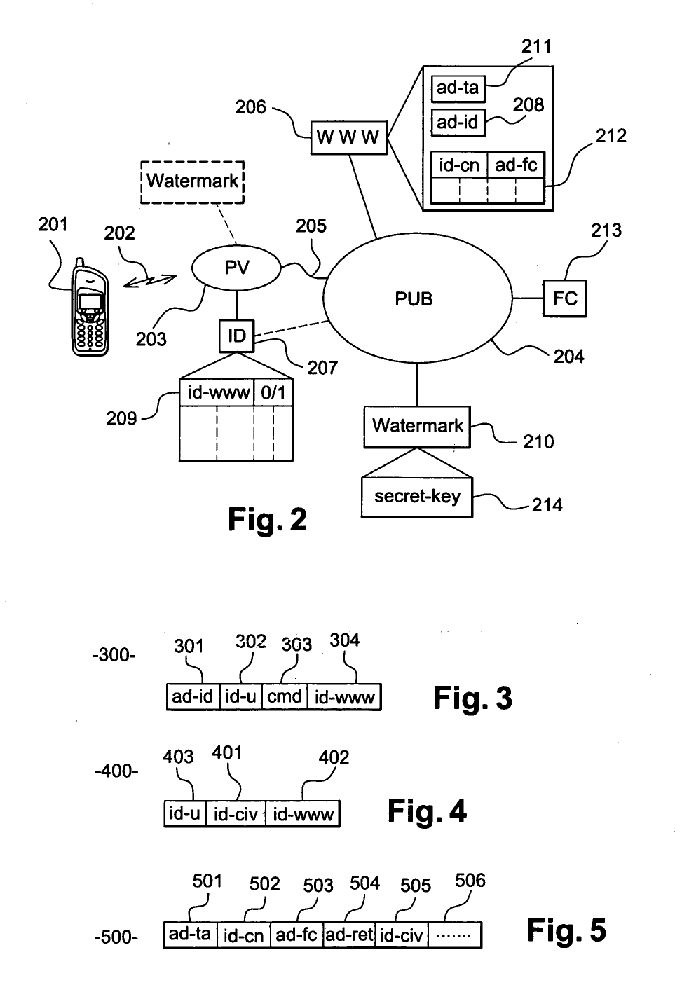

FIG. 2 shows a customer terminal 201 connected by a wireless link 202 to a private network 203. In one example, the terminal 201 is a mobile telephone connected to the network 203 of a mobile telephony operator according to a GPRS type mode. The term used in this case is “private network” or “closed network” because only the operator managing the network 203/can take action on this network whether it is for technical or commercial reasons. In particular, the implementation of the network 203 in terms of infrastructure, protocols and access rights is at the total discretion of the operator managing the private network 203. As opposed to this situation, in a public or open network 204, such as the Internet for example, the protocols and modes of access are known and can be exploited by everybody. FIG. 2 shows that the private network 203 and the public network 204 are interconnected through a connection 205. The connection 205 is formed by means of gateways managed by the operator of the private network 203. These gateways implement the policy of the operator of the private network 203 towards the public network 204. This policy relates to both incoming and outgoing connections of the private network 203. In a simplified way, this policy can be summarized as that of permitting or rejecting these connections according to a variety of criteria, such as the identity of the participants in the connection, the nature of the connection, the volume of data related to the connection etc.: this list of course is not exhaustive.

FIG. 2 also shows a presentation server 206 connected to the public network 204. A presentation server of this kind is also known as a web server, or again as an http (hyper text transfer protocol) server. Such a server is used to host Internet sites, also known as websites. An Internet site has at least one page, also called a web page. Each web page comprises links to other web pages, or other digital contents. A web page is a digital content.

In the step 101, the user of the terminal 201 connects up to the presentation server 206. This connection is set up through the private network 203 and public network 204. This connection is set up by the execution, on the terminal 201, of an Internet navigator type of program, also known as an Internet browser. The fact is that the user of the terminal 261 connects to a website hosted by the server 206. This website enables the user of the terminal 201 to be presented with a certain number of digital contents available for the distribution. These are contents such as pieces of music, films, and programs. Here, a description is given of an implementation of the invention based on an http connection. In practice, the invention takes any type of protocol, including the ftp (file transfer protocol), wtp (wireless transfer protocol) and other protocols: this list of course not exhaustive. In practice, the invention can also be based on unconnected protocols, as well as asynchronous protocols, using for example mail streams, among them the smtp (Simple Mail Transfer Protocol), or using the services offered by private networks 203 (SMS and MMS in the context of mobile networks). In this variant, the presentation server may be a direct consumer of SMS and MMS messages.

It can be noted here that the terminal 201 cannot be limited to a mobile telephony terminal. Indeed, the terminal 201 may also be a personal computer or any device that can be used to make connection with a Web server type of server. The private network 203 is generally the private network of an Internet service provider (ISP).

From the step 101, the invention passes to a step 102 for the selection of a digital content. This selection is made when the user of the terminal 201 scans the website hosted by the server 206. This selection corresponds to an action equivalent to the classic validation of the purchase on an Internet commercial site. The step 102 is terminated when the server 206 has obtained confirmation of the selection made by the user of the terminal 201. This confirmation corresponds to an act of validation made by the user of the terminal 201 through a page of the presentation website. This confirmation enables the user of the terminal 101 to tell the presentation server 206 which digital content he wishes to obtain. In an alternative mode of implementation, the user may provide information on the mode of delivery of the selected content, for example through an e-mail address, a telephone number or a delivery address if a physical carrier is required for the digital content. In practice, a memory of the presentation server 206 enables the association of a digital content identifier with each digital content presented. The selection of a digital content therefore enables the selection, at the same time, of a digital content identifier associated with the selected digital content.

From the step 102, the invention than passes to a step 103 for obtaining an identifier of the user of the terminal 201 by the server 206. This identifier is herein called a durable civil-status identifier. It is an identifier that enables the civil-status identification of a person for several years or even for several decades. In general, this identifier is relevant with respect to the life of the intellectual property rights attached to the digital content.

In a first alternative mode of obtaining a durable civil-status identifier, the presentation server 206 produces a request asking for identification. The presentation server 206 sends this request asking for identification to an identification server 207. The identification server is either connected to the private network 203 or directly connected to the public network 204. The server 206 has a memory 208 enabling it to store an address of the identification server 207. This memory 208 is either provided with information on the configuration of the presentation server 206 or provided with information through the contents of a field of the messages exchanged between the presentation server 206 and the terminal 201 during the steps 101 and 102.

In practice, there is only one operator managing a private network 203. However, each operator is allocated an IP (Internet Protocol, this term referring to the IPv4 and IPv6 protocols) range of addresses when it is connected to the public network 204 through the connection 205. It is thus possible to know which operator the user is a subscriber with, depending on the IP addresses that he uses for communication on the public network 204. Depending on the protocol used within the public network 204, it may be quite simple to identify the operator with whom the user is a subscriber according to the URLs or the DNS (Domain Name System) used during access to the presentation server. The server 206 is therefore in practice capable of associating an address of an identification server with each incoming connection (step 101). The presentation server 206 is therefore capable of determining the identification server to which an identification request must be sent as a function of the IP presented to it by the user who has selected a digital content. To this end, in one alternative embodiment, the memory 208 is divided into several lines, each line corresponding to a range of IP addresses. Each line has two columns, a first column to describe a range of IP addresses and a second column to associate an IP address of an identification server with the description of the place.

The identification demand request also comprises the Internet address or any unspecified identifier of the user generated by the system 205 in the steps 101 and 102. FIG. 3 shows a request 300 asking for identification. The request 300 comprises at least:
one recipient field 301 comprising the address of the identification server 207, namely the address read in the memory 208,
one field 302 identifying the user, this field comprising an identifier with which the user has presented himself to the presentation server 206,
one optional control field 303 informing the server receiving the request that it is a request asking for identification,
a sender field 304 comprising an identifier, generally an IP address, of the presentation server 206 sending the request asking for identification this field being capable, according to one variant, of being supplemented by an enciphered piece of information or an electronic signature if an authentication is requested by the server 207.

The request 300, once produced is sent to the server 207.

The server 207 ascertains that:
1—the field 304 of the request 300 truly corresponds to a server authorized to ask for identification,
2—the field 302 truly corresponds to one of its subscribers. The term “subscribers” must be understood to mean entities that are subscribers with the operator managing the network 203 and have delegated the identification function to the server 207.

If a request asking for identification goes through both verifications, it is approved.

The first verification is made through a table 209 of the identification server 207. This table associates a value with an identifier, for example an IP address, this value indicating whether or not a request asking for identification, coming from an apparatus presenting this identifier, must be responded to or not. This authorization to request an identifier may also be based on the sharing of a piece of information (for example a password or a secret key) between the server 207 and the requesting server. In the same way, this authorization may be subordinated to the result of cryptographic computations used to validate an authentication, which may be mutual or one-sided, or even be an electronic signature (using a PKI or Public Key Infrastructure type technology and X509 certificates). By default, if the identifier is not present in the table 209, there is no response to a request asking for identification. If the identifier is present in the table 209, then the authorizations associated with this identifier are consulted.

For the second verification, an operator obviously knows the way to address his subscriber during his connections. In the context of the use of the IP protocol in the networks 203, the ranges of addresses that were assigned to the operator of the network 203 at the level of the connection 205 enable this verification to be made easily. Furthermore, when the user of the terminal 201 made connection to the server 206, the operator of the network 203 assigned an IP address to the terminal 201. The operator is therefore in a position, when the server 207 receives the identification demand, to make a civil-status identification of the user of the terminal 201. Indeed, when the identification demand is received, the user of the terminal 201 has still not received confirmation of its selection by the server 206, and hence the terminal 201 is still connected to the public network 204 pending this confirmation and hence the IP address of the field 302 of the request 300 is still assigned to this user. However, this IP address will be assigned to another user almost as soon as the user of the terminal 201 is disconnected from the public network 204. It is therefore not a durable and convenient identifier. Thus, at this point in time, the operator of the network 203, and hence the server 207, can make a civil-status identification of the person to whom the IP address has been assigned. Indeed, the server 207 has access to the network 203 and its equipment, at least by delegation of authorization on the part of the operator managing the network 203. In particular, the identification server 207 has access to the device*s responsible for assigning IP addresses to the private network 203 subscribers wishing to connect up through the public network 204. These device*s do not allocate any IP address to a terminal that they cannot identify. These device*s include the HLRs (Home Location Registers), VLR (Visitor Location Register) and GGSN (Gateway GPRS Support Node).

The server 207, having access to the device*s of the private network 203, can therefore give a durable civil-status identifier in response to the request asking for identification. A durable civil-status identifier of this kind is, for example, a MSISDN type telephone number, a social security number, an identity card number, the URL of the place of storage of an electronic identity certificate (for example of the X509 type), or any other identity that the operator of the network 203 undertakes to be capable of assigning to an individual with a civil status for a durable period. It may be recalled here that the term “durable” is understood to mean a period comparable to the duration of the rights attached to the digital contents and/or compatible with the lifetime of the carrier of the digital contents. A durable period can therefore be measured in years and preferably in decades. In one variant, the durable civil-status identifier is dated. In this variant, the durable civil-status identifier is therefore the concatenation of an identifier and of a date or of a single serial number or of any other piece of information enabling the identification in time of the user associated with this identifier. This makes it possible especially to manage the reassigning of MSISDN numbers. Again according to this variant, the use of an identifier based on an IPVR type IP address is made possible but, in this case, a large volume of data has to be stored over a very lengthy period of time. Indeed, it is necessary to store all the IP sessions of all the subscribers, in addition to their MSISDN number, thus making the identification of a person through a durable civil-status identifier costly in terms of resources. According to another variant of this durable civil-status identifier, an IP v6 address may be permanently assigned to a subscriber (as in the case of a Social Security number). In another variant, this durable civil-status identifier is the result of the enciphering of an MSISDN type number and of the associated parameters by the operator of the network 203 using a secret enciphering method. This enables the use of methods producing durable civil-status identifiers that are variable in time, thus preventing the server 206 from establishing statistics on an MSISDN type identifier for example.

The response to an authorized request asking for identification is a message 400 addressed to the server 206. The message 400 then comprises at least one durable civil-status identifier field 401 and one recipient field 402 comprising an address of the presentation server 206. Optionally, the message field 400 comprises a field 403 identical to the field 302. This response may be authenticated, protected in integrity and confidentiality by cryptographic techniques and conventions set up between the servers 206 and 207 so as to have a high level of trust in the data exchanged.

In a second alternative embodiment for obtaining a durable civil-status identifier, this identifier is actually transmitted as soon as the terminal 201 is connected to the presentation server 206. Indeed the connection of the terminal 201 is made through the private network 203. The operator of the network 203 is therefore capable of the interception, for pre-processing, of the request sent out by the terminal 201 during this connection. In particular, a device of the network 203 can process the frames sent out by the terminal 201 as a function of the address of the recipient of these frames. If this address is present in the table 209, then the network 203 modifies the frames so as to include therein a durable civil-status identifier of the user of the terminal 201. The server 206 therefore has direct knowledge of a durable civil-status identifier of the user. In another alternative embodiment, this durable civil-status identifier is associated with an electronic signature technique used to authenticate the origin of the request and hence to certify the validity of the identifier used upon reception by the server 206. Again, in another variant, this durable civil-status identifier may have its confidentiality protected while it is being conveyed to the server 206.

From the step 103, the invention passes to a step 104 for the transmission of watermarking information to a watermarking server 210 connected to the network 210. This transmission is done through a watermarking request. FIG. 5 illustrates a request of this kind produced by the presentation server 206. A watermarking request 500 comprises at least:
a recipient field 501 comprising an address of the watermarking server, this address being known to the presentation server 206 through a watermarking server address memory 211. The memory 211 is the counterpart of the memory 208 but is used for the watermarking servers. In the same way as in the case of an identification server address, a watermarking server address may be associated with a user's address zone,
a field 502 identifying a digital content. The field 502 comprises an identifier of the digital content selected during the step 102, this identifier being therefore known to the server 206,
an address field 503 of the server 213 of the contents supplier capable of supplying the selected digital content at the step 102. The presentation server 206 comprises a table 212 associating, with each digital content identifier, an address of a contents server of a contents supplier, this table being filled on the basis of an agreement between the service provider managing the presentation server 206 and at least the contents provider managing the server 213. The aim is to be able to associate an address of a contents server with each digital content. The exchanges between the servers 206 and 213 can implement cryptographic means to ensure mutual authentication of the parties, and the confidentiality and integrity of the exchanges,
a distribution address field 504, the distribution address having been provided by the user of the terminal 201 during one of the steps 101 or 102, such a distribution address being, for example, an IP address (in this case, this IP address may be the address of the field 302), a telephone number (MSISDN) if the distribution is done online, or again, for example, a mail address, a postal delivery address if the distribution is done off-line,
a field 505 comprising the durable civil-status identifier obtained at the step 103,
a field 506 comprising, if necessary, other information that has to be watermarked such as the current date, a duration of validity of the rights acquired over the digital content, the identity of the author of the digital content, an identifier of the service provider managing the presentation server 206, the description of the rights acquired (for example the number of users, authorization of distribution etc.).

Once produced, the message 500 is sent to the watermarking server 210 and the invention passes to a step 105 for the watermarking of the digital content selected at the step 102.

In the step 105, the server 210 uses the information pertaining to the fields 502 and 503 to obtain the digital content proper. The watermarking server 210 therefore sends a request to the contents server 213 to obtain a digital content. This digital content is the one identified by the field 502. In one variant, the message 500 also comprises an identifier of the presentation server 206 so that the contents server can ascertain that the demand for obtaining digital content truly comes from an entity authorized to send it. In this variant, this identifier of the server 206 is also transmitted by the watermarking server 210 to the contents server 213. For this verification, the contents server can also seek to identify the watermarking server. This identification is done either simply by the address of the response to the request by which the watermarking server 210 seeks to obtain a digital content or through more developed and cryptographic means of the invention which are not exhaustive. Either the contents server 213 knows this response address and accesses the request, or it does not know it, and does not transmit the digital content in response to the request. This knowledge takes the form, for example, of an identification memory in the server 213. This identification memory then enables the recording of a list of identifiers which are then known to the server 213. If the request to obtain a digital content is validated, then the server 213 sends the digital content identified by the field 502 to the watermarking server 210. This is then referred to as a digital content obtained by the watermarking server 210.

Following the step 105, the watermarking server implements a secret-key watermarking algorithm, the secret key being recorded in a memory 214 of the watermarking server 210. A secret-key algorithm is preferred because, at present, this type of algorithm is far more robust than public-key algorithms. In future, the trend could get balanced or reversed and public-key algorithms could then become more relevant.

The watermarked information on the digital content obtained is the information contained in the fields 505 and 506. The result of the watermarking is an obtained and watermarked digital content that is sent to the address contained in the field 504 during a step 106 for the transmission of the obtained and watermarked digital content.

The address contained in the field 504 may be the IP address of the terminal 201, namely the address that it had during the previous steps, especially the steps 101 and 102. The address contained in the field 504 may be the IP address of the server 206, in which case it is the server 206 that takes responsibility for distributing the obtained and watermarked digital content. The address contained in the field 504 may be an e-mail address. The address contained in the field 504 may be the MSISDN of the subscriber or any other telephone number at the choice of the subscriber who has acquired the digital content. In this case, the digital content is distributed by a telephone call to the purchaser, a sound broadcast or the downloading of the digital content. The address contained in the field 504 may be a postal address in which case the obtained and watermarked digital content is recorded on a carrier, namely a floppy, CD or removable hard disk, said carrier being sent by post to the postal address.

The method according to the invention therefore enables many modes of implementation. Among these, the modes known as on-the-fly modes can be distinguished from disconnected modes. A disconnected mode is a mode in which the user of the terminal 201 receives the digital content selected by a channel other than the one used to select it. In these disconnected modes, the watermarked digital content is typically received by the user of the terminal 201 either by downloading techniques that may or may not use one of the extension ports of the terminal 201 (such as infrared, bluetooth or serial link ports), or by e-mail or by post. For an on-the-fly mode, the watermarked digital content is transmitted as if the presentation site were also a downloading site. In this case, the digital content is either watermarked and then transmitted to the user of the terminal 201, or watermarked as and when it is transmitted to the user of the terminal 201.

In the description, all the servers are managed by different entities. However a variety of alternative embodiments can be envisaged. Thus, in one alternative embodiment, the watermarking server is managed by the operator controlling the private network. In another alternative embodiment, the watermarking server is managed by the provider of digital contents. In another alternative embodiment, the presentation server is managed by the provider of digital contents. In another alternative embodiment, the presentation server and the watermarking server are managed by the provider of digital contents and, finally, in yet another alternative embodiment, the watermarking server delivers the contents to the user of the terminal.

These alternative embodiments simplify the installation of the invention because, if an entity combines functions to the utmost extents namely the functions of presentation, watermarking and the supply of digital contents, all these cumulated functions can be installed in one and the same server, thus making it possible to greatly simplify communications between servers, since these functions become internal to the single server. Thus, the performance can be significantly improved and the verification patterns can be considerably simplified.

An interesting alternative embodiment is the one in which the operator managing the private network also manages the watermarking server. This operator can then propose a complete solution for the protection of digital contents without resorting to third parties.

A valuable variant is the one in which the user accesses the presentation server through a voice type of communication (a telephone call) and wherein navigation through the offers of contents can be steered by the use of extended DTMF frequencies.

The solution of the invention can be applied to all types of digital contents, and with all types of watermarking algorithms, without any detriment to the chosen mode of distribution.

1. A method for the protection of a digital content provided by a server of contents of a digital contents provider comprising the following steps:
a presentation server of a provider proposing access to digital contents accepts a connection by a user who is a subscriber with an operator controlling a private network and is setting up connection to said presentation server by means of a customer terminal and via at least this private network,
the user selects a digital content from among those presented by the presentation server,
wherein the method comprises the following steps:
the presentation server obtains, from an identification server, an identifier called a durable civil-status identifier of the user, this durable civil-status identifier enabling the operator controlling the private network and having provided said durable civil-status identifier to make a durable civil-status identification of the user,
the presentation server transmits watermarking information comprising at least the durable civil-status identifier of the user and an identifier of the digital content selected by the user to a watermarking server, for the watermarking of the selected digital content.

2. A method according to claim 1, wherein:
the watermarking server obtains the selected digital content from the content server, and produces a watermarked digital content incorporating the watermarking information transmitted by the presentation server and the selected and obtained digital content, the watermarked digital content being a file in the format of the selected and obtained digital content,
the watermarking server delivers the watermarked digital content to the user.

3. A method according to claim 1, wherein the watermarking information comprises information on the digital management of the rights associated with the digital content.

4. A method according to claim 1, wherein the watermarking information comprises information for limiting the use of the digital content.

5. A method according to claim 1, wherein the private network is a telephony network.

6. A method according to claim 1, wherein all or part of the user's durable civil-status identifier is a telephone number.

7. A method according to claim 1, wherein the watermarking server is managed by the operator controlling the private network.

8. A method according to claim 1, wherein the watermarking server is managed by the digital contents provider.

9. A method according to claim 1, wherein the presentation server is managed by the digital contents provider.

10. A method according to claim 1, wherein the obtaining of a durable user civil-status identifier by the presentation server is subjected to the approval of the identification server, this approval being given as a function of an identifier of the sender of an identification request or an authentication of the sender of the request.

11. A method according to claim 1, wherein the exchanges between the presentation, identification, watermarking, and contents servers are protected by a mutual authentication of the parties, mechanisms of integrity control, mechanisms providing for the confidentiality of the exchanges, mechanisms guaranteeing the non-repudiation of exchanges, and mechanisms implementing cryptographic resources and conventions.

12. A device for the protection of a digital content provided by a contents server of a digital contents provider, wherein the device comprises a customer terminal capable of making connection with a presentation server through at least one private network, the presentation server being capable of presenting the user of the customer terminal with digital contents, the presentation server being furthermore capable of obtaining, from an identification server, a durable user civil-status identifier enabling the operator who controls the private network and has provided said durable user civil-status identifier to make a user civil-status identification, the identification server being also capable of authorizing or not authorizing the issuance of the durable civil-status identifier as a function of the sender of the identification request, the presentation server being also capable of transmitting the durable user civil-status identifier and a digital content identifier to a watermarking server so that the watermarking server produces a watermarked digital content, the watermarking server being capable of obtaining the digital content to be watermarked from a digital contents server, the watermarking server being also capable of delivering the watermarked digital content.
